(19) United States
(12) Patent Application Publication
(10) Pub. No.: US 2006/0148670 A1
(43) Pub. Date: Jul. 6, 2006

(54) Coated sodium percarbonate particles, process for their preparation, their use and detergent compositions containing them

(75) Inventors: Juergen H. Rabe, Rheinbrohl (DE); Henk L.J. Venbrux, Tervuren (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Brussels (BE)

(21) Appl. No.: 10/539,472

(22) PCT Filed: Dec. 22, 2003
(86) PCT No.: PCT/EP03/14815

§ 371 Date: Sep. 15, 2005

(30) Foreign Application Priority Data
Dec. 24, 2002 (EP) 02102888.1

(51) Int. Cl. C11D 3/00

(52) U.S. Cl. 510/375

(57) ABSTRACT

Coated sodium percarbonate particles containing a sodium percarbonate core surrounded by at least one coating layer comprising at least one inorganic coating material, the coated particles having a content of available oxygen of at least 3% by weight, and being fizzy to such an extent that 2 g of the coated particles dissolved in 50 ml of water at 20° C. generate more than 0.4 ml of gas after 2 min. Process for the preparation of such coated sodium percarbonate particles comprising a heat treatment.

The present invention is related to sodium percarbonate particles with fizzing properties (also called effervescent properties).

It is known, as disclosed in the British patent GB 1494543, to treat uncoated sodium percarbonate particles by heating at a temperature of 75 to 135° C. for a period of time determined by the temperature, i.e. during 2-6 h at 75° C. and during 5-30 min at 135° C. The so obtained product presents an improved rate of dissolution, so that it can be used as bleaching agent for clothing for instance, and becomes effervescent However, when incorporated into detergent compositions, where it is brought into contact with substances which enhance the decomposition of sodium percarbonate, its stability becomes too poor.

The present invention aims to overcome this drawback by providing a new product which presents fizzing properties and thus an improved rate of dissolution when used as bleaching agent in an aqueous medium, and which is sufficiently stable to be incorporated into detergent compositions which contain substances that are detrimental to its stability, such as zeolites.

The invention is therefore related to coated sodium percarbonate particles containing a sodium percarbonate core surrounded by at least one coating layer comprising at least one inorganic coating material, the coated particles having a content of available oxygen of at least 3% by weight, and being fizzy to such an extent that 2 g of the coated particles dissolved in 50 ml of demineralised water at 20° C. generate more than 0.4 ml of gas after 2 min.

“Fizzy property” intends to denote the capacity to generate gas, for instance in the form of visible bubbles, when dissolved in water, the gas escaping from the water. The gas can be mainly oxygen.

One of the essential characteristics of the invention resides in that the sodium percarbonate inside the core material, although it is surrounded by a protective coating layer, still presents fizzing properties. It has indeed been shown surprisingly that the presence of a protective stabilizing coating layer which has the function of protecting the sodium percarbonate core from the outer CONFIRMATION COPY atmosphere and from other surrounding detergent constituents, does not affect the fining properties of the sodium percarbonate inside the core.

The method used to measure fizzing according to the invention consists in dissolving 2 g, or 1 g if the product is very fizzy, of the sodium percarbonate particles in 50 ml of demineralised water at 20° C. during 2 min without stirring. The amount of gas generated during these 2 min is measured by displacement of water in a connected graduated tube.

The coated sodium percarbonate particles of the invention present generally fizzing properties to such an extent that, when dissolving 2 g, or 1 g if the product is very fizzy, at least 0.5 ml of gas is generated in the method described above, in particular at least 0.6 ml, values of at least 0.7 ml being usual. Sodium percarbonate particles which generate in the above method volumes of at least 0.8 ml of gas give good results, those generating volumes of at least 0.9 ml being particularly satisfactory and those generating volumes of at least 1.0 ml of gas being especially preferred. The gas volumes generally do not exceed 10 ml, in particular not exceeding 8 ml, and in most cases not exceeding 5 ml.

The coated sodium percarbonate particles of the invention present usually a content of available oxygen of at least 5% by weight, in particular at least 7.5% by weight, contents of at least 10% by weight being satisfactory and those of at least 11% by weight being possible. The content of available oxygen is generally at most 14% by weight, especially at most 13% by weight. The content of available oxygen is measured by titration with potassium permanganate after dissolution in sulfuric acid (see ISO standard 1917-1982).

The inorganic coating material present in the coating layer of the coated sodium percarbonate particles of the invention can contain one or more materials selected from alkali metal and/or alkaline earth metal (particularly sodium or magnesium) salts of mineral or other inorganic acids and especially sulfate, carbonate, bicarbonate, phosphate and/or polymeric phosphates, silicates, borates and the corresponding boric acids. Particular combinations of coating agents include carbonate/sulfate, and boric acid or borate with sulfate and the combination of a) sulfate, carbonate, carbonate/sulfate, bicarbonate, boric acid, borate, boric acid/sulfate, or borate/sulfate, with b) silicate. Preferably, the inorganic coating material contains sodium silicate, sodium borate, boric acid, sodium carbonate, sodium sulfate, magnesium sulfate or one of their mixtures.

The coating layer present in the sodium percarbonate particles of the invention represents in general from 0.1 to 20% by weight of the coated sodium percarbonate particles, in particular from 0.5 to 10% by weight, values from 1 to % by weight giving good results.

The coated sodium percarbonate particles of the invention usually have a 90% dissolution time of at least 0.5 min, in particular at least 0.9 min.

Generally, the 90% is at most 3 min, especially at most 2.5 min. The 90% dissolution time is the time taken for conductivity to achieve 90% of its final value after addition of the coated sodium percarbonate particles to water at 15° C. and 2 g/l concentration. The method used is adapted from ISO 3123-1976 for industrial perborates, the only differences being the stirrer height that is 1 mm from the beaker bottom and a 2 liter beaker (internal diameter 120 mm).

The coated sodium percarbonate particles of the invention have generally a mean diameter of at least 400 μm, in particular at least 500 μm. The mean diameter is usually at most 1200 μm, especially at most 900 μm.

The coated sodium percarbonate particles of the invention usually have a bulk density of at least 0.8 g/cm³, in particular at least 0.9 g/cm³. It is generally at most 1.2 g/cm³, especially at most 1.1 g/cm³. The bulk density is measured by recording the mass of a sample in a stainless steel cylinder of internal height and diameter of 86.1 mm, after running the sample out of a funnel (upper internal diameter 108 mm, lower internal diameter 40 mm, height 130 mm) placed 50 mm directly above the receiver.

The coated sodium percarbonate particles of the invention usually have an attrition measured according to the ISO standard method 5937-1980 of at most 10%, in particular at most 8%, especially at most 4%. The attrition is in most cases at least 0.05%.

The coated sodium percarbonate particles of the invention usually have a thermal stability, measured using microcalorimetry at 40° C., of at most 12 μW/g, especially at most 4 μW/g. Values of at most 3 μW/g give good results. The thermal stability is in most cases at least 0.1 μW/g. The measurement of thermal stability consists of using the heat flow or heat leakage principle using a LKB 2277 Bio Activity Monitor. The heat flow between an ampoule containing the coated sodium percarbonate particles and a temperature controlled water bath is measured and compared to a reference material with a known heat of reaction. The coated sodium percarbonate particles of the invention present in general a moisture pick-up when measured in a test conducted in a humidity room at 80% relative humidity and 32° C. after 24 hours, which varies from 1 to 50 g/1000 g sample. It varies in particular from 5 to 30 g/1000 g sample, and is preferably from 10 to 15 g/1000 g sample. The moisture pick-up is measured by the test described in the international application WO 97/35951 of SOLVAY XEROX at page 7, line 25-page 8, line 6, the content of which is incorporated herein by reference.

The coated sodium percarbonate particles of the invention can be obtained by a process comprising a first step in which the sodium percarbonate core particles are prepared, at least one subsequent coating step in which the core particles are coated with the coating material, and a heat treatment between the first step and the subsequent step, or during the subsequent step, or after the subsequent step, the heat treatment being carried out by heating the particles up to an end temperature T and maintaining the particles during a period t at this end temperature T, T (expressed in ° C.) and t (expressed in min) corresponding to the formula
T≧0.000567t²−0.24t+114,490 when T is up to 110° C., and
T≧−2t+150 when T is above 110° C.

The present invention therefore also concerns a process for the preparation of the above-described coated sodium percarbonate particles, comprising a first step in which sodium percarbonate core particles are prepared, at least one subsequent coating step in which the core particles are coated with the coating material, and a heat treatment between the first step and the subsequent step, or during the subsequent step, or after the subsequent step, the heat treatment being carried out by heating the particles up to an end temperature T and maintaining the particles during a period t at this end temperature T, T (expressed in ° C.) and t (expressed in min) corresponding to the formula
T≧0.000567t²−0.24t+114,490 when T is up to 110° C., and
T≧−2t+150 when T is above 110° C.

The first step of the process of the invention can be any known process for the preparation of sodium percarbonate core particles. It can be for instance a liquid crystallization process such as the one described in the international application WO 97/35806 of SOLVAY INTEROX, optionally followed by a conventional drying step. It can also be a fluid bed granulation process. The first step can be carried out by reacting a hydrogen peroxide solution with a sodium carbonate solution. Alternatively, it can also be a direct process by reaction of a hydrogen peroxide solution with solid sodium carbonate and/or bicarbonate.

In the case of a liquid crystallization process followed by a drying step, or in the case of a fluid bed granulation process, the sodium percarbonate core particles obtained in the first step of the process of the invention are dry particles of sodium percarbonate containing in general less than 1.5% by weight of water, in particular less than 1% by weight of water, a water content of at most 0.8% by weight being most preferred. In the case of a liquid crystallization-process without drying step, the sodium percarbonate core particles obtained in the first step of the process of the invention are wet particles containing commonly more than 1% by weight of water, the water content being generally up to 15% by weight.

The subsequent coating step of the process of the invention can be carried out by any known coating process, such as by bringing the sodium percarbonate core particles in contact with a solution of the coating material or with a slurry of the coating material or with the coating material in powder form. Any type of mixing process or fluid bed reactor can be used for this purpose.

The heat treatment of the process of the invention is the step which seems to confer the fizzing properties to the sodium percarbonate particles. It can be carried out before (i.e. between the first step and the subsequent step), during or after the coating step. It is preferably carried out after the coating step. When it is carried out in a separate process step, it can be done in any reactor, such as in a fluid bed reactor, oven or in a circulating air oven. A fluid bed reactor in which the sodium percarbonate particles are fluidized by an upward flow of hot air is preferred.

The heat treatment of the process of the invention consists in heating up the sodium percarbonate particles up to an end temperature T and maintaining the particles during a period t at this end temperature T. T and t respond to the formula given above. T is generally from 80 to 140° C., in particular from 90 to 130° C., temperatures ranging from 100 to 120° C. being particularly satisfactory. The period t is commonly ranging from 5 min to 4 h, in particular from 5 min to 1.5 h, periods ranging from 5 min to 60 min being advantageous.

The heat treatment can be carried out at any pressure. Pressures near or equal to atmospheric pressure are preferred.

The heat treatment of the process of the invention is advantageously followed by a cooling step. This can be done in a fluid bed with cooling air, by contact with cooled plates, by cooling with air in a thin layer, or in a cooled screw conveyor. The sodium percarbonate particles are preferably cooled to a temperature below 70° C., especially below 30° C.

The sodium percarbonate particles of the invention can advantageously be used as active bleach constituent in detergent compositions.

The present invention therefore concerns also the use of the above-described sodium percarbonate particles as active bleach in detergent compositions.

The present invention also concerns detergent compositions containing the above-described sodium percarbonate particles as active bleach constituent. The detergent compositions can also contain a builder, either zeolitic or non-zeolitic. The detergent compositions can also contain other constituents such as surfactants, anti-redeposition and soil suspension agents, bleach activators, optical brightening agents, soil release agents, sud controllers, enzymes, fabric softening agents, perfumes, colours and processing aids.

The detergent compositions can take any form such as powders, tablets, liquids, etc.

### EXAMPLES

Commercial coated sodium percarbonate particles of SOLVAY with an initial content of available oxygen of 13.96% by weight have been heat treated in a fluid bed with constant air supply at different temperatures. The time and temperature of the heat treatments are given in the table below. 500 g of coated sodium percarbonate particles were used per test. The thus treated particles were then cooled down to ambient temperature. The so obtained particles were analyzed in order to measure their final content of available oxygen and their fizzyness according to the method described above by dissolving 1 g. The results are given in the table below.

| | | Temperature | | |
|---|---|---|---|---|
| | Time t of the | T of the heat | Final content of | |
| | heat treatment | treatment | available oxygen | Fizzyness |
| Example | (min) | (° C.) | (% wt) | (ml) |
| 1 | 240 | 90 | 13.69 | 0.5 |
| 2 | 150 | 100 | 13.49 | 1.1 |
| 3 | 60 | 110 | 12.99 | 2.0 |
| 4 | 45 | 120 | 12.39 | 3.2 |
| 5 | 30 | 130 | 9.75 | 5.8 |
| 6 | 15 | 140 | 9.69 | 6.15 |

1-11. (canceled)

12. Coated sodium percarbonate particles comprising a sodium percarbonate core surrounded by at least one coating layer comprising at least one inorganic coating material, the coated particles having a content of available oxygen of at least 3% by weight, and being fizzy to such an extent that 2 g of the coated particles dissolved in 50 ml of water at 20° C. generate more than 0.4 ml of gas after 2 min.

13. The coated sodium percarbonate particles according to claim 12, being fizzy to such an extent that 2 g of the coated particles dissolved in 50 ml of water at 20° C. generate at least 1 ml of gas after 2 min.

14. The coated sodium percarbonate particles according to claim 12, being fizzy to such an extent that 1 g of the coated particles dissolved in 50 ml of water at 20° C. generates at least 0.4 ml of gas after 2 min.

15. The coated sodium percarbonate particles according to claim 12, having a content of available oxygen of at least 10% by weight.

16. The coated sodium percarbonate particles according to claim 12, wherein the inorganic coating material is selected from the group consisting of sodium silicate, sodium borate, boric acid, sodium carbonate, sodium sulfate, magnesium sulfate and mixtures thereof.

17. A process for the preparation of the coated sodium percarbonate particles of claim 12, comprising a first step in which the sodium percarbonate core particles are prepared, at least one subsequent coating step in which the core particles are coated with the coating material, and a heat treatment carried out between the first step and the subsequent step, or during the subsequent step, or after the subsequent step, the heat treatment being carried out by heating the particles up to an end temperature T and maintaining the particles during a period t at the end temperature T, T (expressed in ° C.) and t (expressed in min) corresponding to the formula:
T≧0.000567t²−0.24t+114.490 when T is up to 110° C., and
T≧−2t+150 when T is above 110° C.

18. The process according to claim 17, in which the end temperature T of the heat treatment ranges from 80 to 140° C.

19. The process according to claim 17, in which the period t of the heat treatment ranges from 5 min to 4 h.

20. The process according to claim 17, wherein the heat treatment is carried out in a fluid bed reactor in which the particles are fluidized by an upward flow of hot air.

21. A process of preparing a detergent composition with active bleach, comprising adding the coated sodium percarbonate particles of claim 12, as active bleach constituent, in a detergent composition.

22. Detergent compositions comprising the coated sodium percarbonate particles of claim 12 as active bleach constituent.
